(19) United States
(12) Patent Application Publication
(10) Pub. No.: US 2007/0132305 A1
(43) Pub. Date: Jun. 14, 2007

(54) Mudskipper wheels, tires and vehicles

(76) Inventor: Donald E. Scruggs, (US)

Correspondence Address: Donald E. Scruggs, 4464 Walnut Ave., Chino, CA, 91710, US

(21) Appl. No.: 11/592,533

(22) Filed: Nov. 3, 2006

Related U.S. Application Data
(60) Provisional application No. 60/748,816, filed on Dec. 10, 2005.

(51) Int. Cl. B60B 19/00

(52) U.S. Cl. 301/5.1

(57) ABSTRACT

A series of paddlewheels and vehicles having specially shaped paddles and with tires around the outside circumference of the paddles, made to run on firm ground, such as roadways, dirt and packed sand and able to move directly into mud, bogs, marshes, snow, loose sand and water without the need to change equipment.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to paddlewheels having small cross section tires encircling their periphery and vehicles using these paddlewheels to travel in water, mud, bogs, sand and snow as well as on firm surfaces.

### BACKGROUND OF THE INVENTION

Currently a number of types of vehicles are built to travel through water and on various kinds of terrain. Many are used for military applications and in such commercial applications as mining, surveying and riparian and sea shore projects. Military and commercial vehicles of this type are usually heavier than recreational vehicles and incorporate large tires or tracks for land locomotion. Most such land and water commercial and military vehicles and a few recreational vehicles have an added propeller system for propulsion in water. Many military, commercial and recreational vehicles incorporating tires in their designs are mostly used for on and off road travel where surfaces are fairly firm, but not for continuous duty in deep mud and water.

When a tire equipped vehicle moves from a firm material, such as a road way, to a wetter environment such as a pond, bog or lake, the tires are known to load up with mud while traveling in the area between the firm material and the water. This loading of mud in treads and on the tire causes the tire to lose traction, spin free, and not move the vehicle in the desired direction. This occurs because the adhesion of the mud to the tire is greater than the cohesion of the mud to itself. The vehicle then needs some sort of assistance to get to the water or at least get out of the mud. Once the mud is crossed and the vehicle is in the water, a secondary drive is needed as regular off-road tires do not affect the water enough to provide propulsion.

The off-road vehicle market is dominated by all terrain vehicles (ATVs) and off highway recreational vehicles (OHRVs). Most vehicles in this category use wide, low pressure pneumatic tires to traverse rough ground and some have special ground contact belts and tracks over wheels. They are mostly made for light duty travel over a wide range of dry and nearly dry land areas.

Such ATVs and OHRVs can usually traverse rough dirt, packed sand and mildly rocky areas, but not snow, mud, bogs and water. They normally rely on a light footprint spreading their weight over a wide area and engaging and putting pressure on many particles of the traversed material to get traction. They can often traverse short sections of loose materials if they acquire speed and momentum before entering these materials.

These recreational ATVs and OHRVs are not normally designed to be useable on a continuous basis in deep water or on mud or snow over a few inches deep. Once the loose material is deep enough that it can squeeze from under the tire and can no longer compact under the footprint of the vehicle, traction is lost.

Loss of tire traction is somewhat the same in dry sand as in mud, except that dry sand does not stick to the tire as does mud. Sand particles pack up into tire treads and the sand particles immediately outside the tire and the sand packed into the tire tread separate under load from the sand in the surface to be traversed and fail to provide traction.

Some other special vehicles, having wide, flat belts with cleats on their surface contact areas are built to be used on snow. By spreading the vehicle weight over a wide area of snow and generating forward thrust by the cleats working against the cohesion of the snow, they are able to move forward from a stopped position in all but the lightest snow. Once in motion they rely on speed and momentum to cross over lighter snow and more difficult areas. The manufacturers of these types usually recommend that they not be used on terrain other than that covered by several inches of snow and not at all on rough ground, mud and or in water.

Several different types of wheeled vehicles are built to operate in liquid mud, bogs, marsh areas and water. These usually have large diameter tires and special propellers for mud and muddy water. These types commonly rely on speed and momentum to get from firm terrain to water. What is called the twilight area, between firm terrain and water, provides little traction. In addition, the increasing flotation as the vehicle enters the water reduces the vehicle footprint pressure on the wet terrain, which in turn, reduces compaction of the loose particles and thus reduces traction. As a result, many slow moving vehicles bog down between where they can roll on firm ground and where they can float in water and begin to use their auxiliary water propulsion equipment.

A number of other vehicles have been built with combinations of wheels, paddle wheels, tracks, flotation means and propelling devices for use on both land and water. One such vehicle is an amphibian car, which looks like a small convertible automobile with a marine propeller at the rear. Although it chums right along in water, its automotive size tires often make crossing the muddy twilight area between firm ground and water difficult.

Many types of powered water vehicles are made, ranging from boats with inboard or outboard motors to boats with large motors and large aircraft propellers. The common inboard or outboard motor boat is usually trailered to and launched into the water from the trailer.

The motor and aircraft propeller equipped boats, commonly called airboats, are usually trailered and launched in the same fashion as inboard and outboard motor equipped boats. When in day to day use the inboard and outboard motor equipped boats and the airboats are usually left in the water and the user walks to other land transport. Inboard and outboard motor equipped boats are generally acceptable for many types of water related activities. With airboats the noise is at a high level, making them obtrusive to persons seeking quiet and relaxing outdoor activity and difficult as a platform from which to hunt or observe nature.

The comfort of riding in a vehicle having flexible rubber or synthetic rubber pneumatic tires over a vehicle having solid tracks or wheels is well known and desirable. Flexible tires usually perform well on firm surfaces and, with proper shape, structure and tread, can be made to perform satisfactorily on some loose materials and in shallow mud. These tires do not usually perform well in deep snow, fine particulate dirt and loose sand or in silty and slimy mud or in water. They usually just spin in most of these mediums and do not move the vehicle.

Closely spaced and connected cleats on tracks, such as used on military tanks, cause a very hard and relatively uncomfortable ride on firm ground and are known to bog down in snow, loose sand and silty, slimy, mud. Open spaced tracks, such as used on some arctic and swamp vehicles move well through snow, marshes, bogs and most water areas, but also cause uncomfortable riding conditions on firmer surfaces, especially roadways. All of which led to the invention of the Mudskipper Wheels and Vehicles.

### OBJECTS OF THE INVENTION

It is a main object of this invention to provide a wheel, tire and vehicle system to operate on firm surfaces as well as in sand, mud, snow, marshland, bogs and water.

It is another object of this invention to provide a wheel which can be added to an existing vehicle to increase its operating capability in sand, mud, snow, marshland, bogs and water.

It is a further object of this invention to provide an easy to operate vehicle requiring no operator adjustments when changing from one type of material surface to another.

An additional object of this invention is to provide a single vehicle to travel on all types of level firm terrain and also move directly into sand, snow, mud, marshes, bogs and flat water.

An additional object of this invention is to provide a vehicle which can be driven from a highway transport vehicle directly to a body of water a distance away.

### OPERATING PRINCIPALS AND PREFERRED EMBODIMENT

Although the preferred embodiment of this invention is a four wheel drive vehicle with front wheel steering and having all four wheels of the Mudskipper Wheel design, a number of variations are shown herein for special requirements and operating environments.

The preferred embodiment of a Mudskipper Vehicle rolls on firm, lightly rocky, gravely or wet surfaces on narrow cross section, flexible tires mounted around a series of radial Mudskipper paddles. When the vehicle encounters softer materials, the narrow cross section tires sink through the softer material to where the paddles of the Mudskipper Wheels engage the softer materials and help propel the vehicle.

Mudskipper Wheels and Vehicles overcome the shortcomings of a number of the vehicles and systems cited above. They roll comfortably across firm materials on flexible tires and dig in and travel through mud, marshes, bogs, sand, snow and flat water using their paddles.

The paddles and supporting members of a Mudskipper Wheel are shaped and spaced to provide maximum propulsion through loose particulate, mud and water and to allow for the free flow of those materials through the Mudskipper Wheel during operations. The free flow of materials, especially mud, greatly reduces the traction losses currently experienced with conventional tires and tracks.

Additional benefit is achieved by the paddles, support members and center hubs of Mudskipper Wheels being hollow and often foam filled. The wide section, rounded paddles are stronger as beams than commonly used flat panels when pushing through various materials. In addition, by being hollow, they provide a level of floatation to the vehicle. Filling the hollow spaces inside of the paddles, structural members and hubs with foam helps prevent floatation loss if puncture damage is incurred in any of these parts.

Mudskipper Wheels and Vehicles have been especially developed to allow a user to roll along comfortably on firm ground and drive directly into and onto sand, mud, bogs, marshes, ponds and lakes. Being able to traverse all such terrain features makes a Mudskipper equipped vehicle an ideal all terrain platform for outdoor activity.

When operating in sand the narrow cross section tire of the Mudskipper Wheel pushes the sand aside and sinks in to where the paddles begin to work against the sand. Forward motion of the vehicle on which the Mudskipper Wheels are mounted is achieved by the resistance of the sand particles to pass each other and to the weight and speed of the sand being moved rearward by the paddles. As forward motion and speed are achieved the hollow Mudskipper paddles dig in less and the vehicle rises up from being sunk into the sand to where the narrow cross section tires are rolling on the surface of the sand. Usually, if the vehicle slows down, the vehicle sinks back down and the paddles again engage the sand.

Mudskipper Wheel and Vehicle operation in snow is similar to operation in sand. The difference being that while snow particles compress and pack into openings and crevices in regular wheels, tires and tracks, Mudskipper Wheels are designed to handle these materials. As many crevices as possible have been eliminated In the Mudskipper Wheel and Vehicle designs. In addition, as many surfaces as possible within the structure and paddles are made convex to greatly reduce areas to which compacted material can cling and build up. Elimination of crevices and the incorporation of outward rounded surfaces, coupled with flow through spaces between members, act together to greatly mitigate the troublesome build up of snow and other materials in and on Mudskipper Wheels.

Mudskipper Vehicles eliminate the need for positioning a trailer in or next to water and manually handling a recreational vehicle into the water. A Mudskipper Vehicle is normally trucked or trailered on a long distance journey and driven off its transport to nearly anywhere at the desire of the user. Driving a Mudskipper vehicle on roadways, through mud and bogs and into water, without engagement and disengagement of auxiliary equipment is also a sought after benefit. Hunters, fishermen, outdoorsmen, field survey crews, nature lovers and the like can use Mudskipper Vehicles equipped with Mudskipper Wheels in all their outdoor activities.

### DESCRIPTION OF FIGURES

FIG. 1 is an isometric view of a typical Mudskipper Wheel showing its direction of rotation, 49, a Mudskipper paddle, 50, an inside brace, 51, between Mudskipper paddles, a tire rim, 52, for retaining a small cross section tire, 53, a front face of a Mudskipper paddle, 54, an outside brace, 55, between Mudskipper paddles, a hollow hub, 56, at the center of a Mudskipper Wheel, and a spoke, 57, between a Mudskipper paddle, 50, and a hollow hub, 56, the ground contact point, 59, of the narrow cross section tire, 53, and a material surface, 58.

FIG. 2 is an isometric view of a typical Mudskipper Wheel, similar to the one shown in FIG. 1, excepting that it is moving through mud, 60, in the rotation direction, 49, shown, and illustrates how its tire, 61, has sunk down into the mud, 60, to where its Mudskipper paddles, 50 and 65, are engaging the mud and moving the Mudskipper Wheel and the vehicle in a forward direction.

FIG. 3 is an isometric view of a typical Mudskipper Wheel, similar to the ones shown in FIGS. 1 and 2, rotating, 49, except it is moving through water, 64, where the wheel, because of the buoyancy of it and the attached vehicle (not shown), is immersed to no more than the horizontal center line, 62, of the Mudskipper Wheel which allows the Mudskipper paddles, 50 and 65, to exert force on the water and propel the wheel and attached vehicle in a forward direction.

FIG. 4 is a side view of a Mudskipper Wheel showing the narrow cross section tire, 70, an outside brace, 71, a paddle, 72, a spoke, 73 and a hollow hub, 74, with the preferred direction of rotation, 81, also shown.

FIG. 5 is an enlarged cut-away view of two paddles, 72, showing that the opening, 75, between the widest portion of the paddles, 72, should be about equal to the opening, 76, between the rounded base of the paddles and the hollow hub, 74, to keep particle packing at a minimum and provide maximum flow of particle matter, especially mud, through the wheel elements to reduce potential weight increase and slippage between packed mud and terrain surface mud. Direction of rotation, 81, is also shown.

FIG. 6 is an enlarged cut-away view of two differently shaped paddles, 77, from those shown in FIG. 5, in that their faces are curved toward their tips to present a concave surface in the direction of travel, 81. These curved paddles, 77, are found to work slightly better than the flat paddles, FIG. 5, item 72, when used in very silty mud and fine sand. Also illustrated is that the opening, 78, between the widest point at the base of the paddles, 77, and the opening, 79, between the base of the paddles, 77, and the hollow hub, 74, should be about equal to keep particle packing at a minimum and provide maximum flow of particle matter, especially mud, to provide a clear and efficient running wheel.

FIG. 7 is a cross section through the center of a Mudskipper Wheel showing a narrow cross section tire, 70, a rim, 71, paddles, 72, a hollow hub, 74, and an opening, 76, between the paddles, 72, and a hollow hub, 74.

FIG. 8 is an enlarged cut-away cross sectional view of the upper portion of FIG. 7, showing a narrow cross section tire, 70, a rim, 71, a paddle, 72, and an air fill valve, 80, by which to inflate the narrow cross section tire, 70.

FIG. 9 shows a four wheel drive vehicle, 83, resting on a flat surface, 81, with steering wheel, 84, referenced, having added-on Mudskipper Wheels, 85, and a waterproofed, dropped body, 86, for flotation at the correct level to take advantage of the propulsion capability of Mudskipper Wheels.

FIG. 10 is a view from the back of a vehicle similar to that shown in FIG. 9, pointing out the location of a left hand steering wheel, 84, a dropped hull center, 86, which houses the wheel drive mechanisms and increases floatation. Note that the narrow cross section tires, 70, are rolling on and not sinking into a firm surface, 81, providing a smooth ride, by not letting the paddles of the Mudskipper Wheels, 85, contact the flat surface.

FIG. 11 is a cross section cutaway of a typical Mudskipper Wheel, pointing out the location of a narrow cross section tire, 87, a paddle, 88, which only contacts the roll surface (not shown) when the narrow cross section tire, 87, sinks into a soft surface. Also shown for reference is the sidewall, 89, of the vehicle hull and a hydraulic motor and gearbox, 90, within a support tube, 98, which is within a hollow hub, 91, with both the tube and hub mounted and supported by bearings, 97, with the support tube, 98, fastened to the hull sidewall, 89.

FIG. 12 is a plan view of the layout of the Mudskipper Wheels, 85, on a vehicle as shown in FIGS. 9 and 10, with the dropped center, 86, of the hull marked. This vehicle arrangement would be skid steered, unlike the layouts shown in FIGS. 14 and 15.

FIG. 13 is a cutaway cross section of a Mudskipper Wheel similar to the one shown in FIG. 11, except that it is attached to and driven by a drive shaft, 95, which is mounted on bearings, 94, and rotated by a chain drive, 93. For reference, a paddle, 88, and the side wall, 89, of the vehicle hull, are shown and marked. In addition, a axle-to-wheel attachment, 92, is shown. The hollow hub, 91, of the wheel is riding on bearings, 97, which are mounted on a support tube, 98, which in turn is mounted directly to the sidewall, 89, of a vehicle hull. Note that the axle shaft, 95, could be driven by a coupler attached to a power shaft, as in automotive practice, instead of by a chain drive and that these are only two of the possible drives for this type of Mudskipper Vehicle.

FIG. 14 is a plan view of a similar layout of Mudskipper Wheels to that shown in FIG. 12, excepting that the steering of the front wheels, 96 and 97, is of conventional automotive practice, by way of steering arm, 99, and universal joint connection, 100. (See FIG. 15 for additional details.)

FIG. 15 Is a cutaway cross section of a Mudskipper Wheel, having a hollow hub, 91, mounted by bearings on a steerable support tube, 98, which pivots on steering pins, 101, and is controlled by way of a steering arm, 99. A narrow cross section tire, 87, and a paddle, 88, are shown and marked for reference. Also shown is a axle-to-wheel mounting, 92, located in the center of a Mudskipper Wheel, and a universal joint, 100, on the axle shaft, at the point where angular change is made for steering. A vehicle sidewall, 89, is also shown.

FIG. 16 is a side view of a six Mudskipper Wheel, skid steer vehicle having a watertight hull, 106, a steering wheel, 105, shown and marked for reference and Mudskipper Wheels, 108, on the vehicle. Note that the center set, left and right sides, of Mudskipper Wheels are placed lower than the front and rear sets to ease operation during skid steering.

FIG. 17 is a rear view of a Mudskipper Wheeled vehicle referencing the location of its steering wheel, 105, its water tight body, 106, a left side Mudskipper Wheel, 108, and a right side Mudskipper Wheel, 109.

FIG. 18 is a layout, looking up from below, of the six Mudskipper Wheels of the vehicle shown in FIGS. 16 and 17, pointing out its watertight body, 106, and showing its left hand Mudskipper Wheels, 108, and its right hand Mudskipper Wheels, 109. Mudskipper Wheels are made to rotate most efficiently in only one direction and are best not changed from one side of a vehicle to another without also exchanging the inside and outside mounting flanges. This flange exchange provides for the Mudskipper Wheels to rotate in the same direction when on the opposite side of the vehicle. Note that in later FIGS. 25 and 26, outside and inside mounting flanges on Mudskipper Wheels are shown to illustrate that the same Mudskipper Wheel can be used and turned in the most efficient direction on both the right and left side of the same vehicle.

FIG. 19, is a phantom isometric view of a hydraulic and chain driven Mudskipper Vehicle where a steering wheel, 105, a watertight hull, 106, with left side Mudskipper Wheels, 108, and right side Mudskipper Wheels, 109, marked. Also shown is a fuel engine, 122, hydraulic power supply, 121, a left side hydraulic motor, 123, driving chains, 125, which in turn drive the Mudskipper Wheels, 108, on the left side of the vehicle, and a right hand hydraulic motor, 124, driving chains, 126, which in turn drive Mudskipper Wheels, 109, on the right side of the vehicle. This arrangement provides for the vehicle to be skid steered to the left by slowing the left side hydraulic motor, 123, and or speeding up the right side hydraulic motor, 124, or to be skid steered to the right by slowing down the right side hydraulic motor, 124, and or speeding up the left side hydraulic motor, 123. The vehicle is braked by slowing down or stopping the flow of hydraulic fluid through the hydraulic lines, 104, from the hydraulic power supply, 121, through the controls (not marked) to the hydraulic motors, 123 and 124.

FIG. 20 is a plan view of a Mudskipper vehicle showing its watertight hull, 126, steering wheel, 127, front seat, 128, fuel engine, 129, differential gear, 131, a right side drive and brake, 130, and left side drive and brake, 133. Not shown are chain drives from the left side drive and brake, 133, to the left side wheels and a chain drive from the right side drive and brake, 130, to the right side wheels. The vehicle is propelled forward by a fuel engine, 129, driving a differential gear set, 131, which in turn drives a left side drive and brake, 133, and a right side drive and brake, 130. Skid steering to the right is effected by braking the right side drive and brake, 130, which slows the right side Mudskipper Wheels and speeds up the left side Mudskipper Wheels, through the action of the differential. Skid steering to the left is effected by braking the left side drive and brake, 133, which slows the left side Mudskipper Wheels and speeds up the right side Mudskipper Wheels. Also shown is a rear passenger seat, 132.

FIG. 21 is a rear view of the same vehicle as in FIG. 20, showing for reference its center mounted steering wheel, 127, its left side Mudskipper Wheels, 136, and its right side Mudskipper Wheels, 137, and a chain drive, 135, shown inside the cut-away section on the right side of the hull, which receives is power from a chain drive attached to the right side brake and drive, shown as item 130 in FIG. 20. The left hand side of the vehicle is driven similarly through a chain drive between the left side drive and brake, 133, FIG. 20, and the left side wheels, 136, in this FIG. 21.

FIG. 22 is a side view of the vehicle shown in FIGS. 20 and 21, with its watertight hull, 126, and steering wheel, 127, marked for reference. An outside support frame, 138, is shown supporting the outside bearings attached to Mudskipper Wheels, 136. Note that the two middle Mudskipper Wheels are set lower against the ground surface, 140, than the front and rear wheels to provide a cradle effect and better skid steering.

FIG. 23 is a rear view of a vehicle similar to the vehicle shown in FIG. 22, excepting that it is driven by hydraulic motors, 139, attached directly to the inboard shafts of the Mudskipper Wheels, 136 and 137. This arrangement is an alternative to the chain drive shown in FIG. 21.

FIG. 24 shows Mudskipper Vehicles approaching and entering water, 144, from the right, through mud, 146, with the mud being soft enough that the narrow cross section tire, 143, on the rear vehicle has sunk through the mud to where the Mudskipper paddles are engaging the mud and propelling the vehicle forward. The front vehicle, to the left, has entered the water, 144, and its forward section is just beginning to float, where the paddles of the front Mudskipper Wheel, 136, are engaging the water and helping to pull the vehicle into the water, while the Mudskipper Wheels, second, third and fourth from the front, 141, 142 and 147 still have paddles in the mud, propelling the vehicle. When the vehicles move forward into the water, to the left, the paddles on the Mudskipper Wheels break free of the mud by digging some of it out and allowing the wheels to spin more freely, engaging the water and pulling the vehicles into the water.

FIG. 25 is an isometric view of the hullward or inward side of a Mudskipper Wheel showing a hollow hub, 112, an inside mounting flange, 115, a drive shaft member, 116, a water seal, 117, and mounting bolts, 114, which fasten the inside mounting flange, 115, to the hollow hub, 112, on the hull side of the Mudskipper Wheel.

FIG. 26 is an isometric view of the outward side of a Mudskipper Wheel showing a hollow hub, 112, an outside mounting flange, 113, and bolts, 114, by which to fasten the outside mounting flange, 113, to the hollow hub, 112. Note that the bolt pattern in the outside mounting flange, 113, is identical to the bolt pattern of the inside mounting flange shown as item 115 in FIG. 20, which provides for the two flanges to interchange and allow the same Mudskipper Wheel to be used and turn in the most efficient direction on either side of the same vehicle.

FIG. 27 is a phantom isometric view of a differential and chain driven Mudskipper Vehicle showing the relationship of a steering wheel, 156, a steering arm, 152, a left hand hydraulic cylinder, 150, its hydraulic line, 157, leading to a left hand brake, 160, on the left hand chain drive, 168, on the left side and a right hand hydraulic cylinder, 151, which feeds hydraulic fluid to a right hand brake, 162, on the right hand chain drive, 167. Also shown are a fuel engine, 164, supplying the vehicle power, a transmission, 163, coupled to the engine, a automotive type differential, 161, feeding power to the left hand and right hand sides of the vehicle, and left side Mudskipper Wheels, 166, and right side Mudskipper Wheels, 165.

FIG. 28 is a simple hydraulic diagram of a skid steering mechanism where a steering wheel, 170, activates a left master cylinder, 171, which drives a left slave cylinder, 172, when the steering wheel is rotated to the left, or a right master cylinder, 173, drives a right slave cylinder, 174, when the steering wheel is rotated in that direction. Each slave cylinder, 172 and 174, is attached to and causes respective brakes to affect a drive on the left or right side of a vehicle, with such action causing the drives on opposite sides of an automotive type differential gear to slow down and or speed up and thus skid steer a vehicle in a desired direction.

FIG. 29 is a simple hydraulic diagram of a fuel engine or electric motor power supply, 177, driving a hydraulic pump, 178, which drives, through controls, the individual hydraulic motors, 175 and 176, which can be made to operate independent mechanical wheel drive systems on the left and right side of a vehicle.

FIG. 30 is a simple hydraulic diagram of a fuel engine or electric motor power supply, 184, driving a hydraulic pump, 185, which drives, through controls, the individual hydraulic motors, 180, 181, 182, and 183, which can be made to operate independent wheel drive systems on the left and right side of a vehicle.

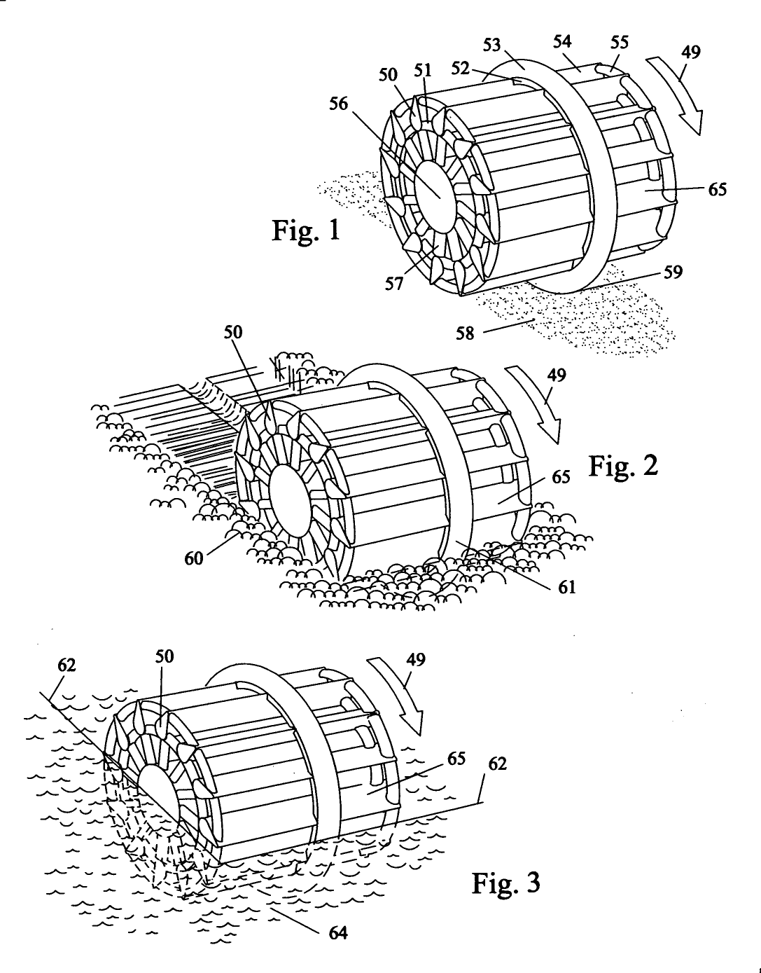

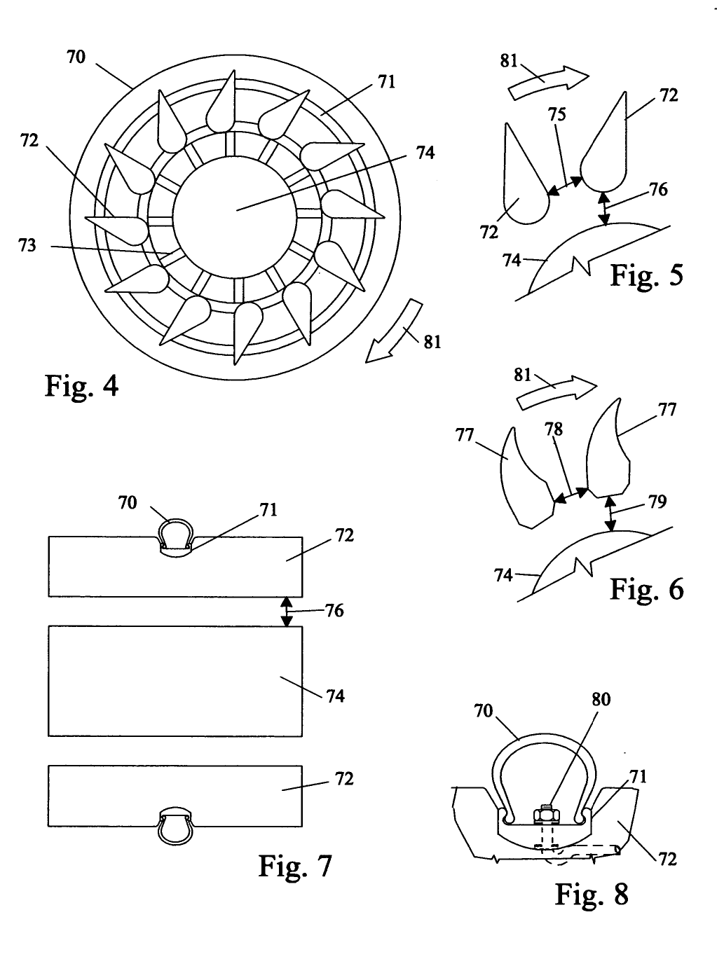

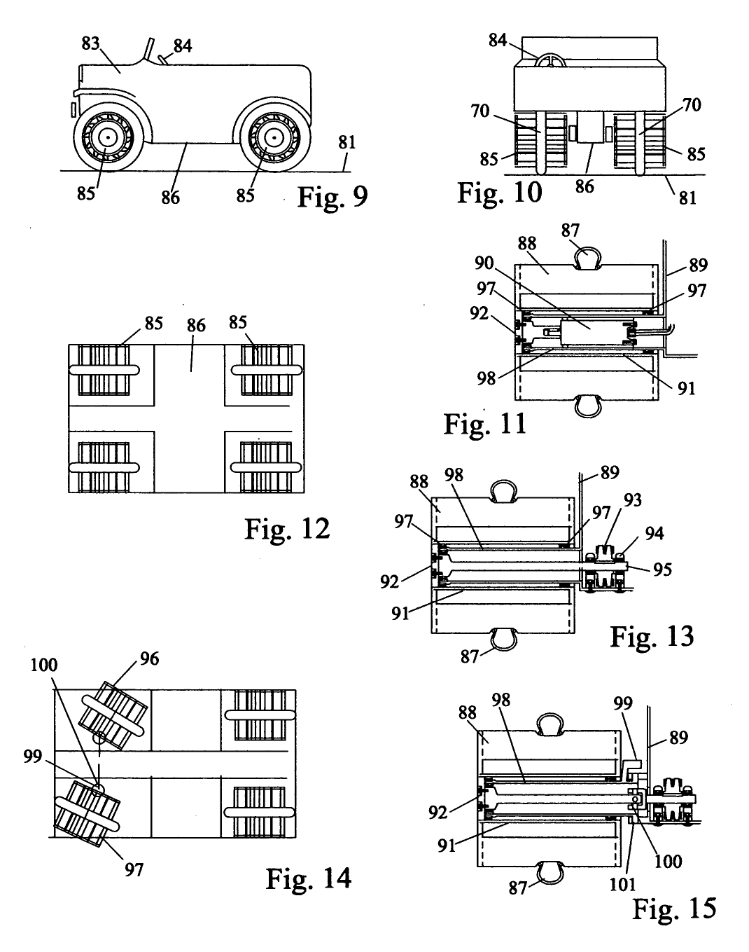

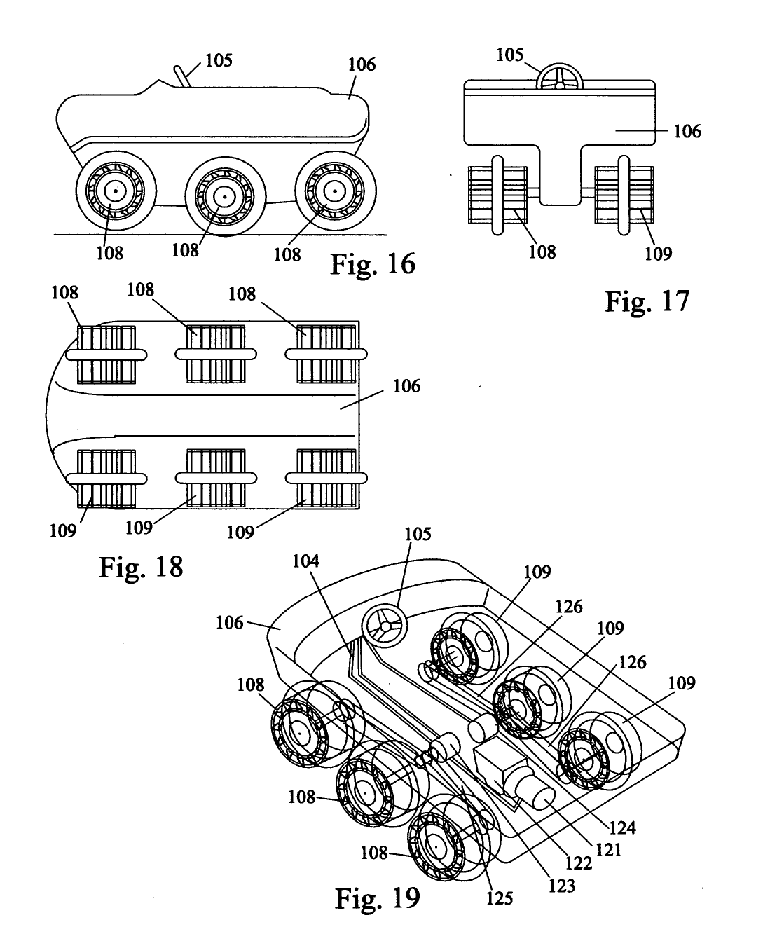

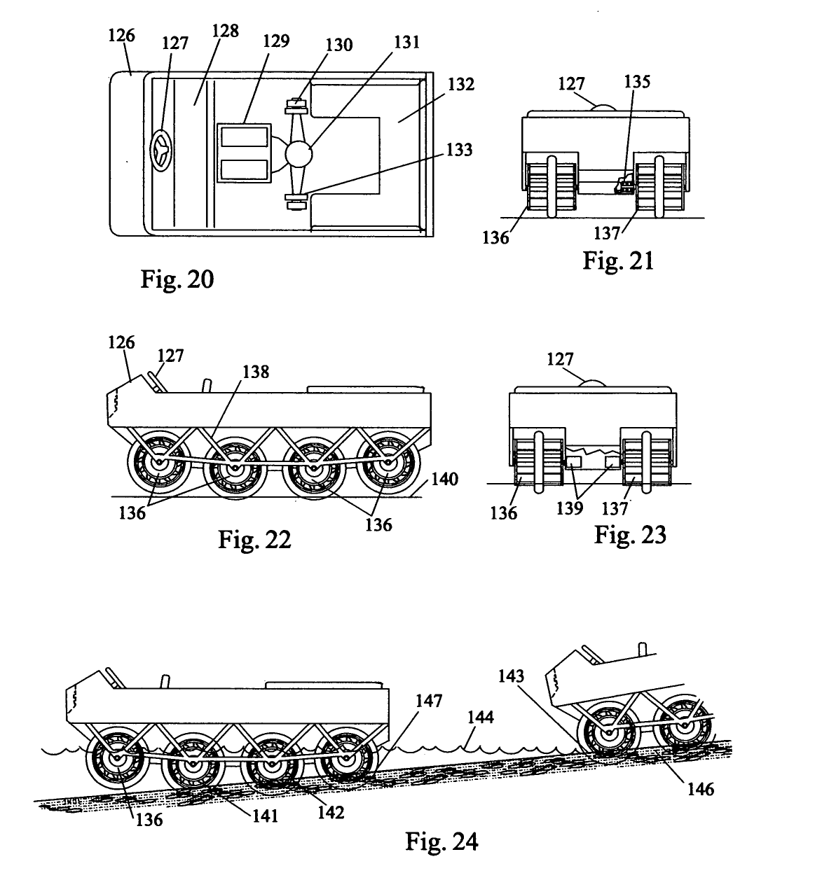

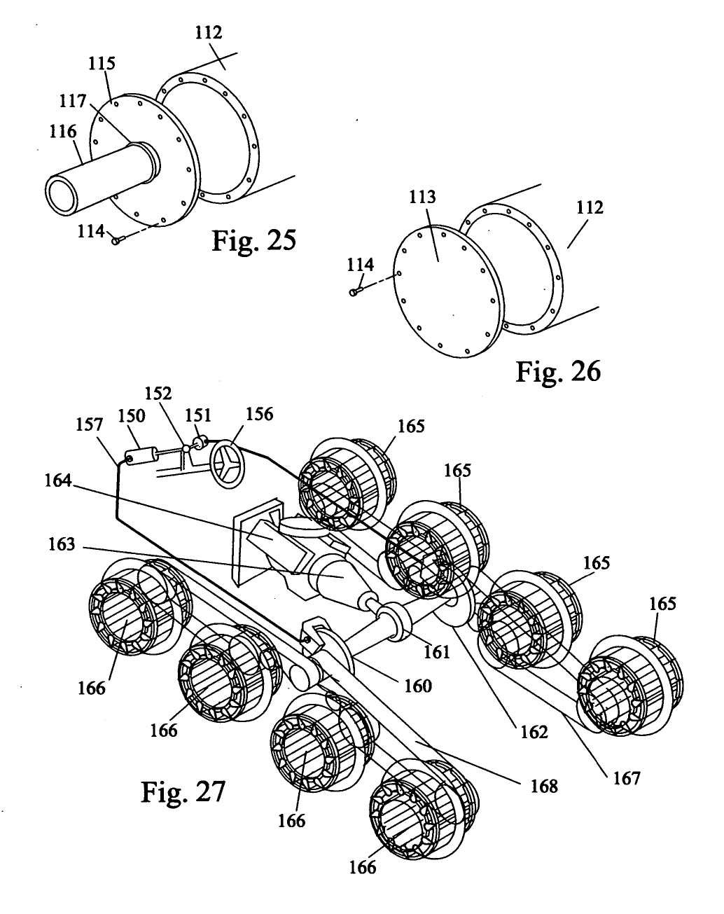

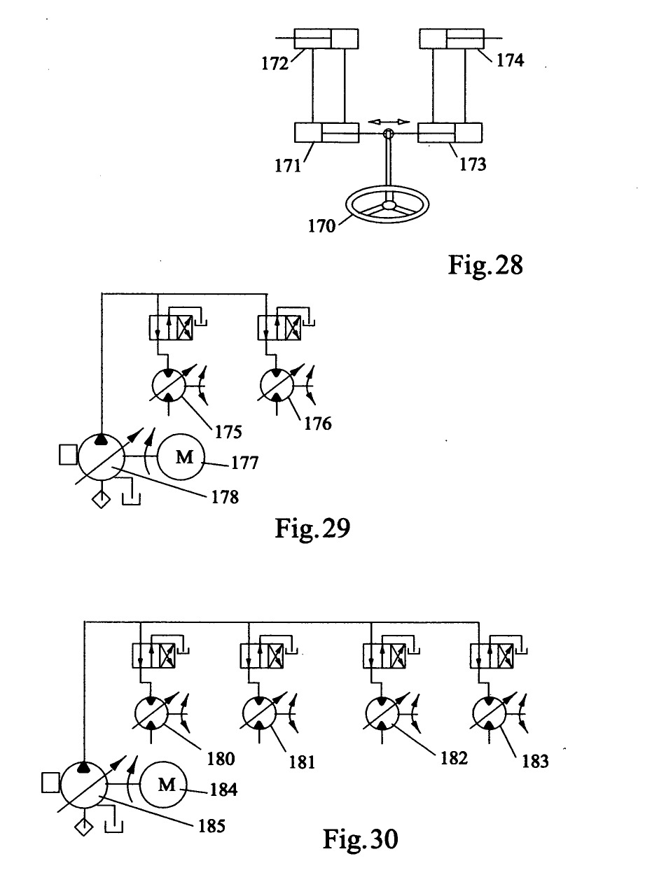

I claim:

1. A paddlewheel with a tire encircling the outside of the paddles and extending out from the periphery of the paddlewheel farther than the paddles.

2. A paddlewheel as in claim 1, having tear drop shaped paddles with the rounded portion of the tear drop towards the center of the wheel and one tapered side of the teardrop along a radial line and facing perpendicular to the direction of rotation.

3. A paddlewheel as in claim 1, having paddles with a thicker section towards the center of the wheel and tapered toward the outside of the wheel.

4. A paddlewheel as in claim 1, having a wide cross section towards the center of the wheel and curved surfaces extending outward and meeting near the outside of the wheel.

5. A paddlewheel as in claim 1, with hollow paddles and a hollow center hub or core.

6. A paddlewheel as in claim 1, with space between the paddles and between the paddles and a center hub or core to provide for the flow through the paddlewheel of loose materials through which the wheel will travel.

7. A vehicle using paddle wheels as cited in claims 1 to 6, above.

8. A vehicle using paddles wheels with a tire encircling the outside of the paddles and extending out from the outermost surface of the paddlewheel farther than the paddles.
